(19) United States
(12) Patent Application Publication
(10) Pub. No.: US 2021/0387869 A1
(43) Pub. Date: Dec. 16, 2021

(54) SYSTEMS FOR WATER DECALCIFICATION

(71) Applicant: Robert Bosch GmbH, Stuttgart (DE)

(72) Inventors: Mordechai KORNBLUTH, Brighton, MA (US); Kaushal SAGAR, Singapore (SG)

(21) Appl. No.: 16/897,929

(22) Filed: Jun. 10, 2020

(51) Int. Cl. C02F 1/36; C08J 5/18; B01D 21/28

(52) U.S. Cl. CPC C02F 1/36; C02F 2101/10; B01D 21/283; C08J 5/18

(57) ABSTRACT

A water decalcification system includes an electroactive polymer (EAP) layer having at least one EAP film, a first electrode contacting the EAP layer and configured to contact a surface of an appliance capable of having at least one interior surface with limescales built up thereon, a second electrode contacting the EAP layer, and an electrical connector configured to connect to an electrical source in electrical communication with the first and the second electrode and configured to apply an electrical voltage to the first and the second electrode. The at least one EAP film deforms in response to the electrical voltage to generate ultrasound vibrational energies transmissive to decalcify the limescales.

### TECHNICAL FIELD

The present disclosure relates to systems for water decalcification, for example, systems for decalcifying limescales in an appliance.

### BACKGROUND

Hard water contains dissolved ions which can precipitate and form deposits, such as calcium carbonate, on surfaces of an appliance contacting water. This deposition phenomenon may be more acute in places where water can be heated, for example, in hot water systems. Due to various configurations and complexities of hot water systems, efficiently removing the deposits on surfaces of the hot water systems can be challenging.

### SUMMARY

According to one embodiment, a water decalcification system is disclosed. The water decalcification system may include an electroactive polymer (EAP) layer having at least one EAP film. The water decalcification system may also include a first electrode contacting the EAP layer and configured to contact a surface of an appliance capable of having at least one interior surface with limescales built up thereon. The first electrode is configured to be situated between the EAP layer and the surface of the appliance. The water decalcification system may further include a second electrode contacting the EAP layer, where the EAP layer is configured to be situated between the first and the second electrode. The water decalcification system may also include an electrical connector configured to connect to an electrical source in electrical communication with the first and the second electrode and configured to apply an electrical voltage to the first and the second electrode. The at least one EAP film may deform in response to the electrical voltage to generate ultrasound vibrational energies transmissive to decalcify the limescales.

According to another embodiment, a water decalcification system is disclosed. The water decalcification system may include an electroactive polymer (EAP) layer having at least one EAP film. The EAP layer is configured to contact a surface of a grounded appliance capable of having at least one interior surface with limescales built up thereon, where the grounded appliance is configured to act as a first electrode. The water decalcification system may also include a second electrode contacting the EAP layer, where the EAP layer is configured to be situated between the surface of the grounded appliance and the second electrode. The water decalcification system may further include an electrical connector configured to connect to an electrical source in electrical communication with the second electrode and configured to apply an electrical voltage to the second electrode. The at least one EAP film may deform in response to the electrical voltage to generate ultrasound vibrational energies transmissive to decalcify the limescales.

According to yet another embodiment, a water decalcification system is disclosed. The water decalcification system may include an electroactive polymer (EAP) layer having at least one EAP film. The EAP layer may have a first side and a second side. The first side may be coated with a first coating layer of a first electrically conductive material. The first electrically conductive material is configured to contact an interior surface of a grounded appliance capable of having at least one interior surface with limescales built up thereon, where the grounded appliance is configured to act as a first electrode. The second side may be coated with a second coating layer of a second electrically conductive material. The second electrically conductive material is configured to contact water in the grounded appliance, where the water is configured to act as a second electrode. The at least one EAP film may deform in response to an electrical voltage applied to the grounded appliance to generate ultrasound vibrational energies transmissive to decalcify the limescales. The electrical voltage may be supplied by an electrical source in electrical communication with the grounded appliance.

### BRIEF DESCRIPTION OF THE DRAWINGS

FIG. 1 depicts a schematic perspective and cross section view of an EAP assembly.

FIG. 2 depicts a schematic perspective view of a first embodiment of a water decalcification system.

FIG. 3 depicts a schematic perspective view of a second embodiment of a water decalcification system.

FIG. 4 depicts a schematic perspective view of a third embodiment of a water decalcification system.

FIG. 5 depicts a schematic perspective view of a fourth embodiment of a water decalcification system.

FIG. 6 depicts a schematic perspective view of a fifth embodiment of a water decalcification system.

FIG. 7 depicts a schematic perspective view of a sixth embodiment of a water decalcification system.

FIG. 8 shows an exemplary block diagram illustrating a method for decalcifying water in an appliance using an EAP assembly.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for applications or implementations.

This present disclosure is not limited to the specific embodiments and methods described below, as specific components and/or conditions may, of course, vary. Furthermore, the terminology used herein is used only for the purpose of describing embodiments of the present disclosure and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Reference is being made in detail to compositions, embodiments, and methods of embodiments known to the inventors. However, it should be understood that disclosed embodiments are merely exemplary of the present disclosure which may be embodied in various and alternative forms. Therefore, specific details disclosed herein are not to be interpreted as limiting, rather merely as representative bases for teaching one skilled in the art to variously employ the present disclosure.

Calcium ions (Ca²⁺) and magnesium ions (Mg²⁺) are common cations found in hard water. These ions can form deposits (e.g. limescales), such as carbonates. Such deposits may form more easily in hot water systems, such as in heat exchangers or steam ovens, where Ca²⁺ or Mg²⁺ ions may react with carbon dioxide at high temperatures to generate the deposits. Because the deposits are thermally insulating, the formation of the deposits adversely affects thermal flows, leading to poor heat transfer in the hot water systems.

Efforts have been made to clean or remove the deposits in water. However, many have focused on applying acidic chemical compounds to the water to dissolve the deposits. A major drawback of this solution is that the addition of the acidic chemical compounds unavoidably brings additional contaminants into the water.

Ultrasonication can be utilized to break apart complexes or linked entities by applying ultrasound vibrational energies. The ultrasound vibrational energies can be absorbed by the complexes or linked entities such that one component of the complexes or linked entities can be dissociated from the other component thereof. However, due to the various configurations of hot water systems, fitting a conventional ultrasonic device to such a hot water system for water decalcification may be difficult. Therefore, there is a need to decalcify water in a more efficient manner.

Aspects of the present disclosure are directed to the utilization of electroactive polymers (EAPs) for the removal of deposits (i.e. limescales) on at least one interior surface of an appliance. In one embodiment, the present disclosure relates to attaching an EAP assembly to an exterior surface of the appliance. In another embodiment, the present disclosure relates to attaching an EAP assembly to an interior surface of the appliance. In either of the embodiments, the EAP assembly includes at least one EAP film deformable in response to electrical stimulations to generate ultrasound vibrational energies for water decalcification.

FIG. 1 depicts a schematic perspective view of an EAP assembly. As shown in FIG. 1, the EAP assembly 100 includes an EAP layer 130 situated between a first electrode 110 and a second electrode 120. The EAP layer 130 may have a thickness in a range of 10 μm to 100 μm. In addition, each of the first and second electrodes, 110 and 120, may have a thickness in a range of 100 nm to 1 μm. The dimensions (e.g. size and thickness) and the crystalline structures of the EAP layer 130 may be adapted to afford ultrasound vibrational energies according to applications of the EAP assembly 100. Additionally, the dimensions (e.g. size and thickness) of the first and second electrodes, 110 and 120, may also be adjusted accordingly based on the applications of the EAP assembly 100. Moreover, due to the hydrophobicity of EAPs, the EAP assembly 100 may be used in an aqueous environment. Because the EAP assembly 100 does not require bulky electronic components to generate high frequency vibrational energies, the EAP assembly 100 may offer excellent flexibility to various applications.

Referring to FIG. 1, the first and second electrodes, 110 and 120, may be in electrical communication with an electrical source (not shown) such that an electrical voltage can be applied to the first and second electrodes, 110 and 120. In one embodiment, the electrical source may be an electrical grid. In another embodiment, the electrical source may be a battery. In yet another embodiment, the electrical source may be wirelessly coupled to the first and second electrodes, 110 and 120.

The first and second electrodes, 110 and 120, may be made of conductive materials. Examples of the conductive materials may include, but not limited to, graphite and carbon black.

In FIG. 1, the EAP layer 130 of the EAP assembly 100 may include at least one EAP film. The at least one EAP film may deform (i.e. physical changes in size and/or shape) under an influence of an electrical voltage applied to the first and second electrodes, 110 and 120. The deformation may lead to the generation of ultrasound vibrational energies. Removing the electrical voltage may subsequently allow the at least one EAP film to return to an original state (i.e. no deformation).

In addition, the frequency and/or amplitude of the ultrasound vibrational energies may be tuned by adjusting the electrical voltage applied to the first and second electrodes, 110 and 120, which may ultimately depend on a specific application of the EAP assembly 100. In one embodiment, the frequency of a vibrational energy may be in a range of 1 to 1000 kHz.

EAPs refer to polymers that can deform in respond to electrical stimulations. Examples of EAPs that may be fabricated into the EAP assembly 100 may include, but not limited to, silicone, polyurethane, acrylate, hydrocarbon rubber, olefin copolymer, polyvinylidene fluoride copolymer, fluoroelastomer, styrenic copolymer, and adhesive elastomer.

Further, non-limiting methods of preparing the EAP assembly 100 may include a rod coating method, a bar coating method, or a screen-printing method.

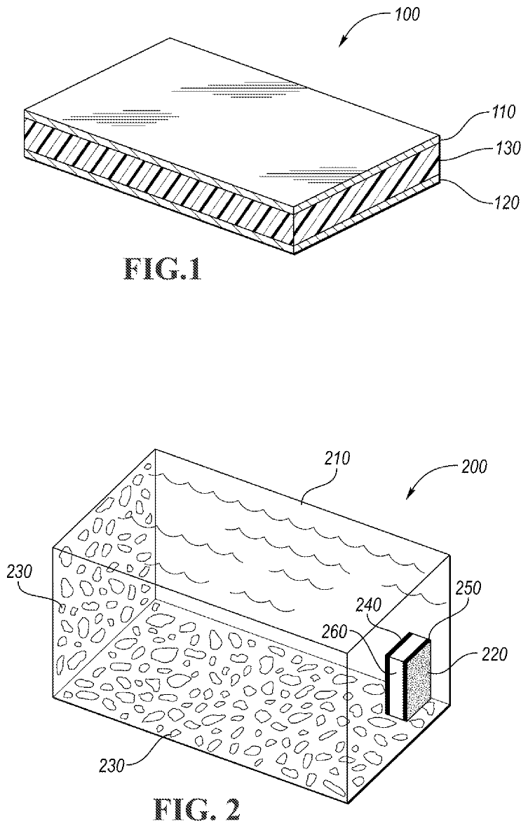

FIG. 2 depicts a schematic perspective view of a first embodiment of a water decalcification system. As shown in FIG. 2, the water decalcification system 200 includes an appliance 210 and an EAP assembly 220 attached to an exterior surface of the appliance 210. The appliance 210 may be any hot water system, including, but not limited to, a heat exchanger, a hot water tank, a steam oven, a dishwasher, or a coffee maker. In this embodiment, the EAP assembly 220 is not contacting the water in the appliance 210. Further, as depicted in FIG. 2, limescales (e.g. carbonates) 230 may be formed and built up on the interior surfaces of the appliance 210 over time.

In this embodiment, the EAP assembly 220 includes a first electrode 240, a second electrode 250, and an EAP layer 260 situated between the first and second electrodes, 240 and 250, as described in FIG. 1. The EAP layer 260 may further includes at least on EAP film, which may deform in response to electrical stimulations.

To remove the limescales 230 on the interior surfaces of the appliance 210, an electrical voltage may be applied to the first and second electrodes, 240 and 250, of the EAP assembly 220. The electrical voltage may then induce the deformation of the EAP layer 260, which subsequently generates ultrasound vibrational energies. The ultrasound vibrational energies may be transmitted to the interior surfaces of the appliance 210, where the ultrasound vibrational energies may be absorbed by the limescales 230 for decalcification. Upon the completion of water decalcification, the electrical voltage may be removed such that the EAP layer 260 may return to an original state.

The electrical voltage may be supplied by an electrical source (not shown) in electrical communication with the EAP assembly 220. For one example, the electrical source may be an electrical grid. For another example, the electrical source may be a battery. For yet another example, the electrical source may be wirelessly coupled to the first and second electrodes, 240 and 250.

Still referring to FIG. 2, the EAP assembly 220 may be removably attached to the exterior surface of the appliance 210. The attachment of the EAP assembly 220 to the appliance 210 may also depend on an exterior structure of the appliance 210. For one example, the EAP assembly 220 may be attached to the exterior surface of the appliance 210 using screws or bolts. For another example, the EAP assembly 220 may include a snap-fit feature configured to mate with a component on the exterior surface of the appliance 210. For yet another example, the EAP assembly 220 may be attached to the exterior surface of the appliance 210 using adhesives. In addition, although FIG. 2 exhibits one EAP assembly attached to the exterior surface of the appliance 210, more than one EAP assembly may be attached to the exterior surface of the appliance 210 for water decalcification.

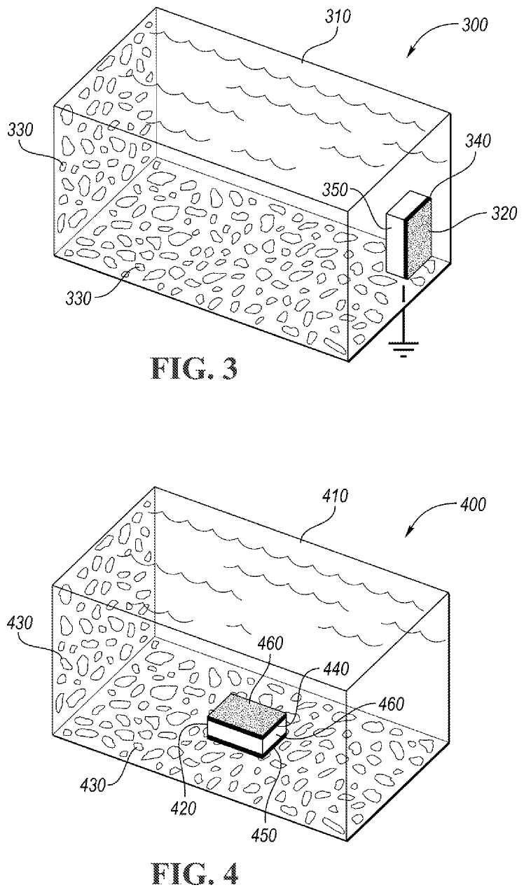

FIG. 3 depicts a schematic perspective view of a second embodiment of a water decalcification system. As shown in FIG. 3, the water decalcification system 300 includes an appliance 310 and an EAP assembly 320 attached to an exterior surface of the appliance 310. In this embodiment, the appliance 310 may be any hot water system, including, but not limited to, a heat exchanger, a hot water tank, a steam oven, a dishwasher, or a coffee maker. Further, as depicted in FIG. 3, the EAP assembly 320 is not directly contacting the water in the appliance 310, and limescales (e.g. carbonates) 330 may be formed and built up on the interior surfaces of the appliance 310 over time.

Referring to FIG. 3, the EAP assembly 320 in this embodiment may include one electrode 340 and an EAP layer 350 attached to the electrode 340. The EAP layer 350 may include at least one EAP film, which may deform in response to electrical stimulations. To operate, the appliance 310 is grounded, acting as another electrode, and the EAP layer 350 is thus situated between the appliance 310 and the electrode 340 of the EAP assembly 320.

To remove the limescales 330 on the interior surfaces of the appliance 310, an electrical voltage may be applied to the appliance 310 and to the electrode 340 of the EAP assembly 320. The electrical voltage may thus cause the EAP layer 350 to deform, generating ultrasound vibrational energies. The ultrasound vibrational energies may then be transmitted to and absorbed by the limescales 330 on the interior surfaces of the appliance 310 for decalcification. Upon the completion of water decalcification, the electrical voltage may be removed such that the EAP layer 350 may return to an original state.

In this embodiment, the electrical voltage supplied to the appliance 310 may be from an electrical grid. In addition, the electrical voltage supplied to the electrode 340 of the EAP assembly 320 may be from an electrical grid, a battery, or an electrical source wirelessly coupled to the electrode 340.

Further, in this embodiment, the EAP assembly 320 may be removably attached to the exterior surface of the appliance 310. The attachment of the EAP assembly 320 may depend on an exterior structure of the appliance 310. For one example, the EAP assembly 320 may be attached to the exterior surface of the appliance 310 using screws or bolts. For another example, the EAP assembly 320 may include a snap-fit feature configured to mate with a component on the exterior surface of the appliance 310. For yet another example, the EAP assembly 320 may be attached to the exterior surface of the appliance 310 using adhesives. In addition, although FIG. 3 exhibits one EAP assembly attached to the exterior surface of the appliance 310, more than one EAP assembly may be attached to the exterior surface of the appliance 310 for water decalcification.

FIG. 4 depicts a schematic perspective view of a third embodiment of a water decalcification system. As shown in FIG. 4, the water decalcification system 400 includes an appliance 410 and an EAP assembly 420 attached to an interior surface of the appliance 410. The appliance 410 may be any hot water system, including, but not limited to, a heat exchanger, a hot water tank, a steam oven, a dishwasher, or a coffee maker. In this embodiment, the EAP assembly 420 directly contacts the water in the appliance 410. Further, as depicted in FIG. 4, limescales (e.g. carbonates) 430 may be formed and built up on the interior surfaces of the appliance 410 over time. It is also possible that limescales 430 may be formed and built up on the surfaces of the EAP assembly 420.

In this embodiment, the EAP assembly 420 includes a first electrode 440, a second electrode 450, and an EAP layer 460 situated between the first and second electrodes, 440 and 450, as described in FIG. 1. The EAP layer 460 may further include at least one EAP film, which may deform in response to electrical stimulations.

To remove the limescales 430 on the interior surfaces of the appliance 410 and on the surfaces of the EAP assembly 420, an electrical voltage may be applied to the first and second electrodes, 440 and 450, of the EAP assembly 420. The electrical voltage may cause the EAP layer 460 to deform to generate ultrasound vibrational energies, which may then be absorbed by the limescales 430 on the interior surfaces of the appliance 410 and on the surfaces of the EAP assembly 420 for decalcification. After the removal of the limescales 430, the electrical voltage may be removed such that the EAP layer 460 may return to an original state.

In this embodiment, the electrical voltage may be supplied by an electrical source (not shown) in electrical communication with the first and second electrodes, 440 and 450. For one example, the electrical source may be an electrical grid. For another example, the electrical source may be a battery. For yet another example, the electrical source may be wirelessly coupled to the first and second electrodes, 440 and 450.

Still referring to FIG. 4, the EAP assembly 420 may be removably attached to the interior surface of the appliance 410. The attachment of the EAP assembly 420 may also depend on an interior structure of the appliance 410. For one example, the EAP assembly 420 may be attached to the interior surface of the appliance 410 using screws or bolts. For another example, the EAP assembly 420 may include a snap-fit feature configured to mate with a component on the interior surface of the appliance 410. For yet another example, the EAP assembly 420 may be attached to the interior surface of the appliance 410 using adhesives. The above methods are only exemplary in nature and that other methods may be employed to accomplish the attachment. In addition, although FIG. 4 exhibits one EAP assembly attached to the interior surface of the appliance 410, more than one EAP assembly may be attached to the interior surface of the appliance 410 for water decalcification.

FIG. 5 depicts a schematic perspective view of a fourth embodiment of a water decalcification system. As shown in FIG. 5, the water decalcification system 500 includes an appliance 510 and an EAP assembly 520 attached to an interior surface of the appliance 510. The appliance 510 may be any hot water system, including, but not limited to, a heat exchanger, a hot water tank, a steam oven, a dishwasher, or a coffee maker. In addition, as depicted in FIG. 5, the EAP assembly 520 directly contacts the water in the appliance 510. Limescales (e.g. carbonates) 530 may be formed and built up on the interior surfaces of the appliance 510 and on the surfaces of the EAP assembly 520 over time.

In this embodiment, the EAP assembly 520 includes one electrode 540 and an EAP layer 550 attached to the electrode 540. The EAP layer 550 may include at least one EAP film, which may deform in response to electrical stimulations. To operate, the appliance 510 is grounded, acting as another electrode, and the EAP layer 550 is therefore situated between the interior surface of the appliance 510 and the electrode 540 of the EAP assembly 520.

Thereafter, upon supplying an electrical voltage to the appliance 510 and to the electrode 540 of the EAP assembly 520, the EAP layer 550 may deform to generate ultrasound vibrational energies. The ultrasound vibrational energies may then be absorbed by the limescales 530 on the interior surfaces of the appliance 510 and on the surfaces of the EAP assembly 520 for decalcification. Upon completion, the electrical voltage may be removed such that the EAP layer 550 may return to an original state.

In this embodiment, the electrical voltage supplied to the appliance 510 may be from an electrical grid. In addition, the electrical voltage supplied to the electrode 540 of the EAP assembly 520 may be from an electrical grid, a battery, or an electrical source wirelessly coupled to the electrode 540.

Further, in this embodiment, the EAP assembly 520 may be removably attached to the interior surface of the appliance 510. The attachment of the EAP assembly 520 may depend on an interior structure of the appliance 510. For one example, the EAP assembly 520 may be attached to the interior surface of the appliance 510 using screws or bolts. For another example, the EAP assembly 520 may include a snap-fit feature configured to mate with a component on the interior surface of the appliance 510. For yet another example, the EAP assembly 520 may be attached to the interior surface of the appliance 510 using adhesives. It should be understood, however, that the above methods are only exemplary in nature and that other methods may be employed to accomplish the attachment. In addition, although FIG. 5 exhibits one EAP assembly attached to the interior surface of the appliance 510, more than one EAP assembly may be attached to the interior surface of the appliance 510 for water decalcification.

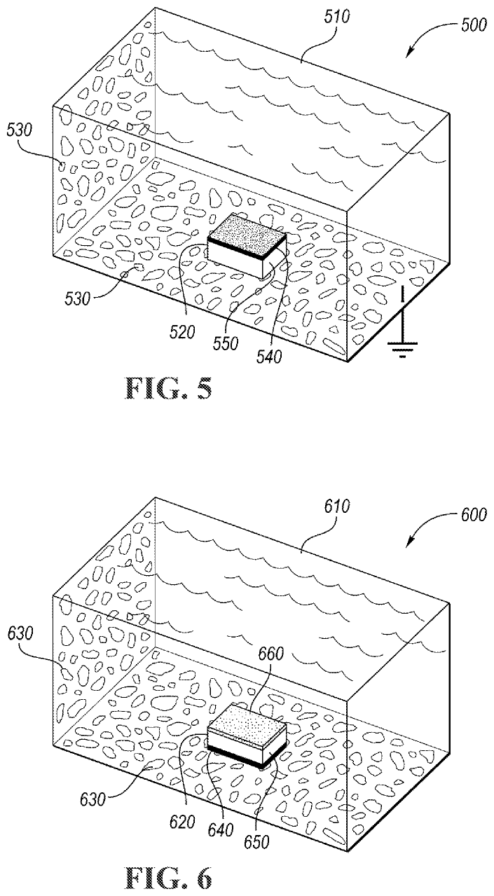

FIG. 6 depicts a schematic perspective view of a fifth embodiment of a water decalcification system. As shown in FIG. 6, the water decalcification system 600 includes an appliance 610 and an EAP assembly 620 attached to an interior surface of the appliance 610. The appliance 610 may be any hot water system, including, but not limited to, a heat exchanger, a hot water tank, a steam oven, a dishwasher, or a coffee maker. As depicted in FIG. 6, the EAP assembly 620 directly contacts the water in the appliance 610, and limescales (e.g. carbonates) 630 may be formed and built up on the interior surfaces of the appliance 610 over time. It is also possible that limescales 630 may be formed and built up on the surfaces of the EAP assembly 620.

In this embodiment, the EAP assembly 620 includes one electrode 640 and an EAP layer 650 attached to the electrode 640. The EAP layer 650 may include at least one EAP film, which may deform in response to electrical stimulations. To operate, the water in the appliance 610 may act as another electrode. As such, the EAP layer 650 may be situated between the electrode 640 of the EAP assembly 620 and the water in the appliance 610. In addition, to protect the EAP layer 650 and to increase electrical conduction between the electrode 640 and the water in the appliance 610, the EAP layer 650 may be coated with a thin layer of electrically conductive material 660.

Specifically, the electrically conductive material 660 may be, but not limited to, polymers or metals. Examples of the polymers may include, but not limited to, polyacetylene, polyaniline, polypyrrole, polythiophene and poly(p-phenylene). Each of the polymers may be mixed with additives, such as, but not limited to, binders or carbon. Further, examples of the metals may include, but not limited to, copper, graphite, titanium, brass, silver, and platinum.

Thereafter, upon supplying an electrical voltage to the electrode 640 of the EAP assembly 620 and to the water in the appliance 610, the EAP layer 650 may deform to generate ultrasound vibrational energies, which may then be absorbed by the limescales 630 on the interior surfaces of the appliance 610 and on the surfaces of the EAP assembly 620 for decalcification. The electrical voltage may then be removed after removing the limescales 630 such that the EAP layer 650 may return to an original state.

Further, the EAP assembly 620 may be removably attached to the interior surface of the appliance 610. The attachment of the EAP assembly 620 may depend on an interior structure of the appliance 610. For one example, the EAP assembly 620 may be attached to the interior surface of the appliance 610 using screws or bolts. For another example, the EAP assembly 620 may include a snap-fit feature configured to mate with a component on the interior surface of the appliance 610. For yet another example, the EAP assembly 620 may be attached to the interior surface of the appliance 610 using adhesives. In addition, although FIG. 6 exhibits one EAP assembly attached to the interior surface of the appliance 610, more than one EAP assembly may be attached to the interior surface of the appliance 610 for water decalcification.

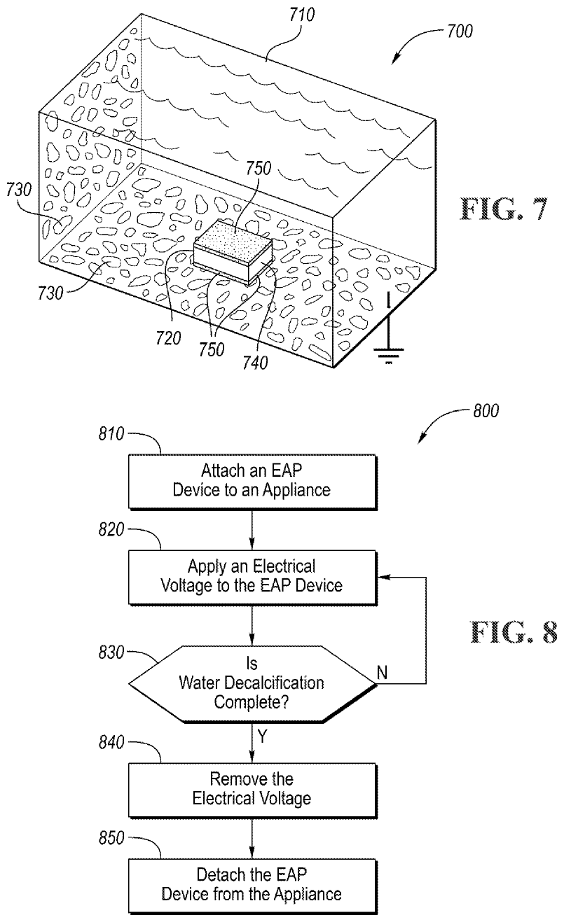

FIG. 7 depicts a schematic perspective view of a sixth embodiment of a water decalcification system. As shown in FIG. 7, the water decalcification system 700 includes an appliance 710 and an EAP assembly 720 attached to an interior surface of the appliance 710. The appliance 710 may be any hot water system, including, but not limited to, a heat exchanger, a hot water tank, a steam oven, a dishwasher, or a coffee maker. As depicted in FIG. 7, the EAP assembly 720 directly contacts the water in the appliance 710. Limescales (e.g. carbonates) 730 may be formed and built up on the interior surfaces of the appliance 710 over time. It is also possible that limescales 730 may be formed and built up on the surfaces of the EAP assembly 720.

In this embodiment, the EAP assembly 720 includes an EAP layer 740, which may further include at least one EAP film. The at least one EAP film may deform in response to electrical stimulations. To operate, the appliance 710 is grounded, acting as a first electrode, and the water in the appliance 710 may act as a second electrode. In addition, a thin layer of electrically conductive material 750 may be coated on two opposite sides of the EAP layer 740 to protect the EAP layer 740 and to increase electrical conduction between the interior surface of the appliance 710 and the water in the appliance 710.

Specifically, the electrically conductive material 750 may be, but not limited to, polymers or metals. Examples of the polymers may include, but not limited to, polyacetylene, polyaniline, polypyrrole, polythiophene and poly(p-phenylene). Each of the polymers may be mixed with additives, such as, but not limited to, binders or carbon. Further, examples of the metals may include, but not limited to, copper, graphite, titanium, brass, silver, and platinum.

To remove the limescales 730 on the interior surfaces of the appliance 710, an electrical voltage may be supplied between the interior surface of the appliance 710 and the water in the appliance 710. The electrical voltage may cause the EAP layer 740 to deform, which generates ultrasound vibrational energies, which may be absorbed by the limescales 730 for decalcification. Upon the completion of water decalcification, the electrical voltage may be removed such that the EAP layer 740 may return to an original state.

In this embodiment, the EAP assembly 720 may be removably attached to the interior surface of the appliance 710. The attachment of the EAP assembly 720 may depend on an interior structure of the appliance 710. For one example, the EAP assembly 720 may be attached to the interior surface of the appliance 710 using screws or bolts. For another example, the EAP assembly 720 may include a snap-fit feature configured to mate with a component on the interior surface of the appliance 710. For yet another example, the EAP assembly 720 may be attached to the interior surface of the appliance 710 using adhesives. In addition, although FIG. 7 exhibits one EAP assembly attached to the interior surface of the appliance 710, more than one EAP assembly may be attached to the interior surface of the appliance 710 for water decalcification.

Now, a method for decalcifying water in an appliance will be described. FIG. 8 shows an exemplary block diagram 800 illustrating a method for decalcifying water in an appliance using an EAP assembly. Referring to FIG. 8, at step 810, an EAP assembly is attached to an exterior or interior surface of the appliance. The EAP assembly may include at least one EAP film, which may deform in response to electrical stimulations. At step 820, an electrical voltage is applied to the EAP assembly such that the at least one EAP film may deform to generate ultrasound vibrational energies. The ultrasound vibrational energies may then be transmitted to and absorbed by the limescales built up on the interior surfaces of the appliance for decalcification. At step 830, if water decalcification is complete, the electrical voltage applied to the EAP assembly may be removed at step 840. Otherwise, the electrical voltage may remain applied to the EAP assembly until completion. Additionally, at step 850, the EAP assembly is detached from the exterior or interior surface of the appliance.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A water decalcification system comprising:
an electroactive polymer (EAP) layer having at least one EAP film;
a first electrode contacting the EAP layer and configured to contact a surface of an appliance capable of having at least one interior surface with limescales built up thereon, the first electrode being configured to be situated between the EAP layer and the surface of the appliance;
a second electrode contacting the EAP layer, the EAP layer configured to be situated between the first and the second electrode; and
an electrical connector configured to connect to an electrical source in electrical communication with the first and the second electrode and configured to apply an electrical voltage to the first and the second electrode, the at least one EAP film deformable in response to the electrical voltage to generate ultrasound vibrational energies transmissive to decalcify the limescales.

2. The water decalcification system of claim 1, wherein the EAP layer has a thickness in a range of 10 μm to 100 μm.

3. The water decalcification system of claim 1, wherein the at least one EAP film includes electroactive polymers selected from the group consisting of silicone, polyurethane, acrylate, hydrocarbon rubber, olefin copolymer, polyvinylidene fluoride copolymer, fluoroelastomer, styrenic copolymer, and adhesive elastomer.

4. The water decalcification system of claim 1, wherein the first electrode has a thickness in a range of 100 nm to 1 μm, and the second electrode has a thickness in a range of 100 nm to 1 μm.

5. The water decalcification system of claim 1, wherein the first electrode includes a first conductive material, the first conductive material being graphite or carbon black, and the second electrode includes a second conductive material, the second conductive material being graphite or carbon black.

6. The water decalcification system of claim 1, wherein the electrical source is an electrical grid or a battery.

7. The water decalcification system of claim 1, wherein the electrical source is wirelessly coupled to the first and the second electrode.

8. The water decalcification system of claim 1, wherein the ultrasound vibrational energies have frequencies in a range of 1 to 1000 kHz.

9. A water decalcification system comprising:
an electroactive polymer (EAP) layer having at least one EAP film, the EAP layer configured to contact a surface of a grounded appliance capable of having at least one interior surface with limescales built up thereon, the grounded appliance being configured to act as a first electrode;
a second electrode contacting the EAP layer, the EAP layer being configured to be situated between the surface of the grounded appliance and the second electrode; and
an electrical connector configured to connect to an electrical source in electrical communication with the second electrode and configured to apply an electrical voltage to the second electrode, the at least one EAP film deformable in response to the electrical voltage to generate ultrasound vibrational energies transmissive to decalcify the limescales.

10. The water decalcification system of claim 9, wherein the EAP layer has a thickness in a range of 10 μm to 100 μm.

11. The water decalcification system of claim 9, wherein the at least one EAP film includes electroactive polymers selected from the group consisting of silicone, polyurethane, acrylate, hydrocarbon rubber, olefin copolymer, polyvinylidene fluoride copolymer, fluoroelastomer, styrenic copolymer, and adhesive elastomer.

12. The water decalcification system of claim 9, wherein the second electrode has a thickness in a range of 100 nm to 1 μm.

13. The water decalcification system of claim 9, wherein the second electrode includes a conductive material, the conductive material being graphite or carbon black.

14. The water decalcification system of claim 9, wherein the electrical source is an electrical grid or a battery.

15. The water decalcification system of claim 9, wherein the electrical source is wirelessly coupled to the second electrode.

16. The water decalcification system of claim 9, wherein the ultrasound vibrational energies have frequencies in a range of 1 to 1000 kHz.

17. A water decalcification system comprising:
an electroactive polymer (EAP) layer having at least one EAP film, the EAP layer having a first side and a second side, the first side being coated with a first coating layer of a first electrically conductive material, the first electrically conductive material being configured to contact an interior surface of a grounded appliance capable of having at least one interior surface with limescales built up thereon, the grounded appliance being configured to act as a first electrode, the second side being coated with a second coating layer of a second electrically conductive material, the second electrically conductive material being configured to contact water in the grounded appliance, the water being configured to act as a second electrode, the at least one EAP film deformable in response to an electrical voltage applied to the grounded appliance to generate ultrasound vibrational energies transmissive to decalcify the limescales, the electrical voltage being supplied by an electrical source in electrical communication with the grounded appliance.

18. The water decalcification system of claim 17, wherein the EAP layer has a thickness in a range of 10 μm to 100 μm.

19. The water decalcification system of claim 17, wherein the first electrically conductive material is selected from the group consisting of polyacetylene, polyaniline, polypyrrole, polythiophene, poly(p-phenylene), copper, graphite, titanium, brass, silver, and platinum, and the second electrically conductive material is selected from the group consisting of polyacetylene, polyaniline, polypyrrole, polythiophene, poly(p-phenylene), copper, graphite, titanium, brass, silver, and platinum.

20. The water decalcification system of claim 17, wherein the electrical source is an electrical grid.
